(19) United States
(12) Patent Application Publication
(10) Pub. No.: US 2014/0067881 A1
(43) Pub. Date: Mar. 6, 2014

(54) MOBILE APPARATUS AND METHOD FOR PROCESSING FILES

(71) Applicant: PANTECH CO., LTD., Seoul (KR)

(72) Inventors: Sung Wook JUNG, Seoul (KR); Woo Yub KIM, Seoul (KR); Moon Sup LEE, Seoul (KR)

(73) Assignee: PANTECH CO., LTD., Seoul (KR)

(21) Appl. No.: 13/790,511

(22) Filed: Mar. 8, 2013

(30) Foreign Application Priority Data
Sep. 3, 2012 (KR) 10-2012-0097212

(51) Int. Cl. G06F 17/30

(52) U.S. Cl. CPC G06F 17/30076
USPC 707/821

(57) ABSTRACT

A mobile apparatus and method for processing files. The mobile apparatus includes: a file manipulation unit configured to receive a file operation request including a file path from an application; a file format discrimination unit configured to discriminate a file format from the file path; a file path changing unit configured to set a target file path based on the file format; and a file processing unit configured to process the operation request on the target file path.

### CROSS-REFERENCE TO RELATED APPLICATION

This application claims priority from and the benefit of Korean Patent Application No. 10-2012-97212, filed on Sep. 3, 2012, which is incorporated by reference for all purposes as if fully set forth herein.

### BACKGROUND

1. Field

The following description relates to a mobile apparatus and a method for processing files for the mobile apparatus.

2. Discussion of the Background

The development of communication technologies and the propagation of smart phones allow users of smart phones to utilize various applications. For example, a photographing application, such as INSTAGRAM, a Social Network Site (SNS) application, such as MYSPACE, and a face recognition application, such as PUDDING FACE Recognition, respectively take photos and store the photo files in a specific directory set in each application. Referring to FIG. 1, in case of using the INSTAGRAM application, image and/or photo files are stored in a file processing path of “root>Instagram>data>picture>aaa.jpg”. In case of the MySpace application, photo files are stored in a file processing path of “root>MySpace>Today>photo>aaa.jpg”, and in case of the TCLOUD application, photo files are stored in a file processing path of “root>Tcloud>backup>photo>aaa.jpg”. As such, different directories are used by different applications to manipulate files having similar properties. When photo files are stored in folders set by various applications, a user may not easily find a directory where a desired photo is stored. This problem leads to great inconvenience when the user wants to operate on files by a property, for example, when backing up files of a smart phone. When a user desires to, for example, back up only photo files, the user should or must back up photo files separately for every directory where photo files are stored. If the user backs up the Root directory, instead of trying to find the various application specific directories, files other than photo files are backed up. This creates noise. In another example, if the user is compressing files by type and if all files in a Root directory are compressed, files other than photo files are also compressed. This also causes noise.

### SUMMARY

Exemplary embodiments of the present invention provide an apparatus and method for manipulating and changing a file path in an operating system of a mobile apparatus.

According to exemplary embodiments, there is provided a mobile apparatus for processing files including: a file manipulation unit configured to receive a file operation request including a file path from an application; a file format discrimination unit configured to discriminate a file format from the file path; a file path changing unit configured to set a target file path based on the file format; and a file processing unit configured to process the operation request on the target file path.

According to exemplary embodiments, there is provided a method for processing files including: receiving a file operation request including a file path from an application; discriminating a file format from the file path; setting a target file path based on the file format; and processing the operation request on the target file path.

According to exemplary embodiments, there is provided a computer for processing files including: a file format discrimination unit configured to discriminate, in case of receiving a file processing request, whether the file has a file format; a file path changing unit configured to change, in the case the file is discriminated to have the file format by the file format discrimination unit, a first file processing path included in the file processing request into a second file processing path; and a storage unit configured to store the file in the second file processing path changed from the file path changing unit.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a tree structure of a path where files generated by various applications are stored according to the related art.

FIG. 2 is a diagram for illustrating the principle of storing files generated by various applications according to the related art.

FIG. 3 is a diagram illustrating a tree structure of a path where files generated by various applications are stored according to exemplary embodiments of the present disclosure.

FIG. 4 is a diagram illustrating an inner configuration of a mobile apparatus according to exemplary embodiments of the present disclosure.

FIG. 5 is a diagram illustrating an inner configuration of a mobile apparatus according to exemplary embodiments of the present disclosure.

FIG. 6 is a diagram illustrating an inner configuration of a mobile apparatus according to exemplary embodiments of the present disclosure.

FIG. 7 is a flowchart for illustrating a method for processing files by using the mobile apparatus according to exemplary embodiments of the present disclosure.

FIG. 8 is a flowchart for illustrating a method for processing files by using the mobile apparatus according to exemplary embodiments of the present disclosure.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Hereinafter, exemplary embodiments of the present disclosure will be described in detail with reference to the drawings.

In the description of the exemplary embodiments, when it is determined that specific description about the may unnecessarily limit the gist of the present disclosure, the detailed description related known functions or configurations may be omitted. In addition, the sizes of constituent elements in the drawings may be exaggerated for description, and do not represent the actually applied sizes.

In addition, exemplary embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Prior to describing the present disclosure with reference to the drawings, the term “mobile apparatus” used herein will be described in brief.

A mobile apparatus may be implemented in various ways and may have various features. The mobile apparatus may include all kinds of devices where a specific application program can operate and its form is not limited. In particular, the mobile apparatus may be a smart phone or a small smart pad including a display, a touch sensor, a motion sensor, an oscillator, a speaker, a communication module or the like.

In addition, the mobile apparatus may include, for example, a processor, an operating system, a network interface, an application program interface (API) and a communications processing system to provide communications between at least one application program and the operating system.

The processing system of the mobile apparatus may be configured to execute various applications programs. The mobile apparatus may communicate with another object, and certain hardware or software for the communication may be loaded therein.

The communications processing system may provide all kinds of communication methods which allow networking between objects. Networking can utilize wired or wireless communication. Exemplary wireless communication systems include 3G, 4G and subsequent methods without being limited to the kind, if the communication function is ensured in the subsequent methods. All kinds of information, such as various kinds of sensor information, voice information, and data information manipulated by the mobile apparatus, may be transmitted to or received from external objects through the mobile apparatus.

In this specification, the file processing path may be interpreted as including a filename.

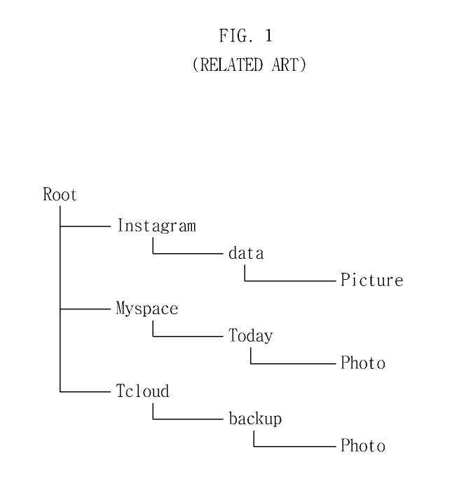

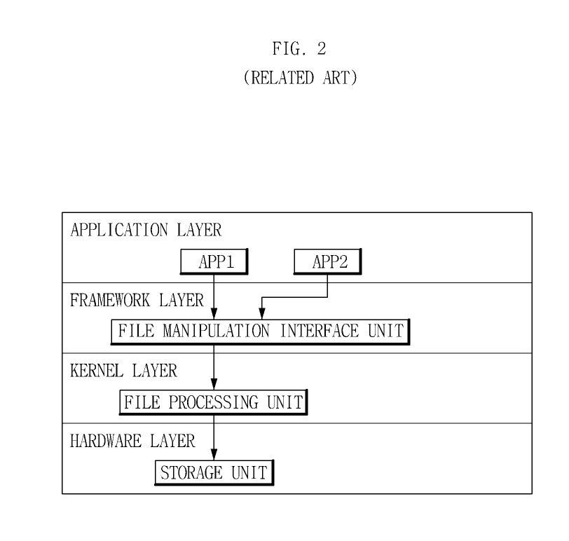

FIG. 1 is a diagram illustrating a directory tree structure where files generated by various applications are stored. FIG. 2 is a diagram illustrating a system for storing files according to the related art depicted in FIG. 1.

Referring first to FIG. 2, an operating system of a mobile apparatus of the related art is discussed.

As shown in FIG. 2, a mobile apparatus has a hardware layer, a kernel layer, a framework layer, and an application or program layer composed of various application programs which operate on the platform. Also provided is a platform for processing and transferring signals input between the various layers to/from the hardware layer.

The platform is classified depending on an operating system of the mobile apparatus into an ANDROID platform, a WINDOWS mobile platform, an IOS platform or the like, which have the same basic roles even though their structures are slightly different.

A platform, such as, the ANDROID platform manages hardware. The platform includes a kernel layer for transferring a request of an application program to the hardware and transferring a response of the hardware to the application program again. The platform also includes a framework layer for managing various application programs. In addition, even though not shown in FIG. 2, a library layer, usually written in C or C++, is provided to connect the hardware to the framework layer and may be included in the framework layer. Regarding the classification standard, the library layer may be classified to be located between the framework layer and the kernel layer.

In case of the WINDOWS mobile platform, the WINDOWS core layer corresponds to the kernel layer, and the platform further includes an interface layer for connecting the core layer to the application program layer and supporting various languages and Application Programming Interfaces (APIs).

In case of the IOS platform, the core OS layer corresponds to the Linux kernel layer, the core service layer is similar to the library layer and the framework layer, and the platform further includes a media layer for giving a multimedia API and a COCOA TOUCH layer for various application programs.

The following exemplary embodiments will be described based on the ANDROID platform, but the present disclosure may be implemented on a platform of the mobile apparatus as described above without being limited to the kind of the platform.

An application which performs a photographing operation will be described as a detail example of FIG. 2. In case of taking a photograph and storing a photo file, an application1 (App1) and an application2 (App2), which perform a photographing operation, send a file processing request including a file processing path to a file manipulation interface unit of a framework layer. For example, the Instagram application transmits a file processing path “root>Instagram>data>picture>aaa.jpg” to the file manipulation interface unit, and the MYSPACE application transmits a file processing path “root>Myspace>Today>photo>aaa.jpg” to the file manipulation interface unit. The file manipulation interface unit may figure out the file processing path from the library API, for example, “open (const char *pathname, int flags).” The application then transfers the received photo file processing path to a file processing unit of the kernel layer by invoking an API of the kernel layer. The file processing unit stores the photo file in a storage unit of the hardware layer based on the file processing path received through an API, for example, “sys_open ( )”. As a result, photo files are stored in individual folders preset by various applications. In case of loading a stored file, the same mechanism is used. However, a file is loaded by giving a file loading request.

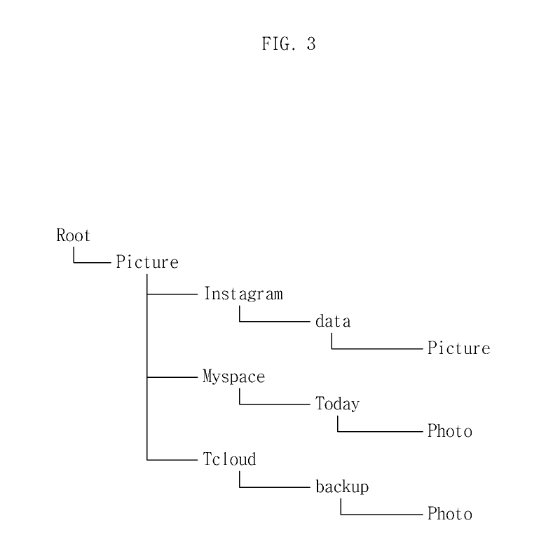

FIG. 3 is a diagram showing a tree structure of a path where files generated by various applications are stored according to an embodiment of the present disclosure. In directory paths of FIG. 1, the directory below the INSTAGRAM, MYSPACE and TCLOUD folders are identical to the directory paths illustrated in FIG. 3. However, above the Instagram, MySpace and Tcloud folders, these folders have a common upper path component or directory, namely, “picture”. To accomplish this, the file processing request changes the file processing paths to have a common upper path according to exemplary. In addition to photo files described above, files subject to the file processing request and manipulation of the file path may include music files, moving picture files, document files or the like. The format of a file is not specially limited, if the file type can be distinguished from other types or kinds of files. A file-type-specific-directory can be provided for file types that are subject to manipulation of the file path.

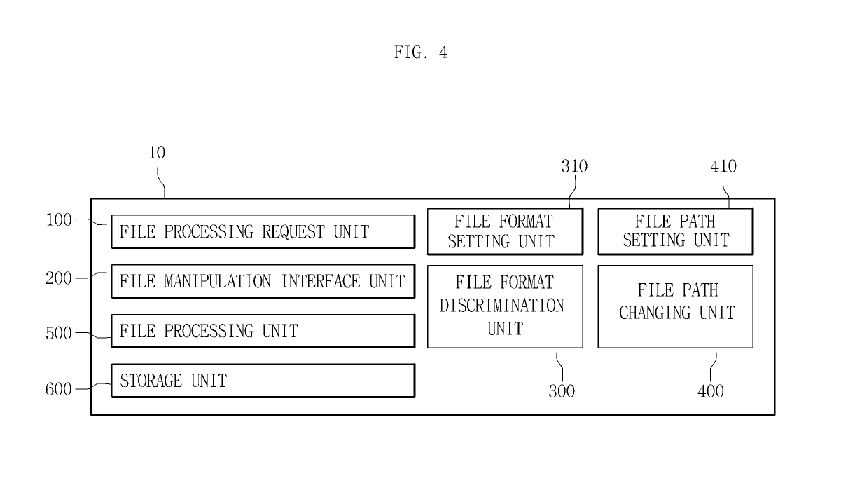

FIG. 4 is a diagram illustrating a first inner configuration of a mobile apparatus 10 according to exemplary embodiments of the present disclosure. Mobile apparatus 10 may include a file processing request unit 100, a file manipulation interface unit 200, a file format discrimination unit 300, a file format setting unit 310, a file path changing unit 400, a file path setting unit 410, a file processing unit 500 and a storage unit 600. Though not illustrated in FIG. 4, modules such as a hardware unit, a communication unit having a communication operation, and storage unit 600 may be included in mobile apparatus 10 regardless of their forms and functions. Also the mobile terminal, the components of the mobile terminal, the devices of the mobile terminal and the units of the mobile terminal herein described, may include or be hardware and/or software, and can also include firmware, to perform various functions of the mobile terminal including those for operating a mobile terminal.

File processing request unit 100 receives a request for processing a file by an application, for example to save or to load a file. The file processing request unit 100 may be an application. The file processing request may include a file processing path set for each application. As described above, the Instagram application includes a path “root>Instagram>data>picture>aaa.jpg”, and the Myspace application includes a path “root>Myspace>Today>photo>aaa.jpg”. In this specification, the file processing path may be interpreted as including a filename. The file processing request unit 100 may store a file processing path in a temporary memory. File processing request unit 100 may directly transfer the path in the form of ASCII codes. File processing request unit 100 may also transfer information about the path as a reference pointer or a value.

File manipulation interface unit 200 receives a file processing request from file processing request unit 100. File manipulation interface unit 200 transfers the file processing request to file processing unit 500, for example, by calling file processing unit 500. The file processing request includes the file processing path described above. The file manipulation interface unit 200 may receive the file processing path from file processing request unit 100 via a library API, for example, “open (const char *pathname, int flags)” of the library layer. In the open API, the pathname is a reference to a string representing the path of the file, and the flags are an attribute value used during execution of the open API. The flags manipulate attributes such as O_RDONLY (read only), O_WRONLY (write only), and O_RDWR (read/write available). A parameter corresponding to the pathname is delivered from file processing request unit 100. The open (const char *pathname, int flags) API makes a system call to an API “sys_open (const *filename, int flags, int mode)” of the kernel layer. The sys_open API will be described later with reference to file processing unit 500. In the process of transferring a pathname parameter, the file processing path is changed by file format discrimination unit 300 and file path changing unit 400. By changing the file path, it is possible to store or load files using the common file processing path requested by various applications.

When a file processing request is received, the file format discrimination unit 300 determines or discriminates the file format based on the file processing path. File format discrimination unit 300 first determines whether the file has a predetermined or specific format. File format discrimination unit 300 may operate in both the framework layer and the kernel layer. In case of operating in the framework layer, file format discrimination unit 300 discriminates or determines whether the file has a predetermined or specific format based on the file processing path received from file manipulation interface unit 200. In case of operating in the kernel layer, file format discrimination unit 300 discriminates or determines whether the file has a predetermined format based on the file processing path received from file processing unit 500.

Files subject to the file processing request may include photo files, music files, moving picture files, document files or the like. However, the format of a file is not specially limited.

Exemplary image or photo file types include: Raster-type ANI, ANIM, APNG, ART, BEF, BMP, BSAVE, CAL, CIN, CPC, CPT, DPX, ECW, EXR, FITS, FLIC, FPX, GIF, HDRi, ICER, IONS, ICO/CUR, ICS, ILBM, JBIG, JBIG2, JNG, JPEG, JPEG 2000, JPEG-LS, JPEG-HDR, JPEG XR, MNG, MIFF, PBM, PCX, PGF, PGM, PICtor, PNG, PPM, PSD/PSB, PSP, QTVR, RAD, RGBE, SGI, TGA, TIFF (TIFF/EP TIFF/IT Logluv TIFF) WBMP, WebP, XBM, XCF, and XPM are available. In addition, Raw-type CIFF, DNG, and ORF, Vector-type AI, CDR, CGM, DXF, EVA, EMF, Gerber, HVIF, IGES, PGML, SVG, VML, WMF, XAR, compound-type CDF, DjVu, EPS, PDF, PICT, PS, SWF, XAML, and associated Exchangeable image file format (Exif), and Extensible Metadata Platform (XMP) are also available.

Exemplary audio types, such as an audio file including a music file, include: WAV, AIF, MID, MP3, WMA, RealAudio, Vorbis, Musepack, AAC, AC-3, DTS, PCM, APE, FLAC, ALAC, WavPack, MLP/Dolby, TrueHD, and DTS-HD.

Exemplary video types, such as a video file including a moving picture file, include: MPG, MOV, WMV, RM, MPEG-1, MPEG-2, MPEG-4 (A)SP, H.264/MPEG-4, AVC, VC-1/WMV, RealVideo, Theora, Microsoft, MPEG4, V2, VP8, and MVC.

File format discrimination unit 300 may discriminate or determine whether the file has a predetermined format based on a file extension or suffix (usually found at a right end of the file path) of the file processing path. For example, when the INSTAGRAM application has a file processing request including a file processing path “root>INSTAGRAM>data>picture>aaa.jpg”, an extension of the file is generally represented at a right end of the file processing path. As described above, the file processing path includes a filename. The extension of a file is a part of the filename, and the filename is generally classified into a title of the file and an extension by using a dot (.). Therefore, if a string of the file processing path is parsed based on the dot (.) and a predetermined number of file extensions are recognized at the right end. As such, it is possible to discriminate or determine whether the file has a predetermined format based on its name.

File format setting unit 310 determines a file format to be discriminated by file format discrimination unit 300. In an embodiment, file format setting unit 310 may be an application operating in the application layer. File format setting unit 310 may set a file format to be discriminated by file format discrimination unit 300 or set a file format according to a selection of a user or according to an arbitrary input. In addition, it is also possible to set at least one file format.

When the file is discriminated to have a predetermined or specific format by file format discrimination unit 300, file path changing unit 400 plays a role of changing the first file processing path included in the file processing request into the second file processing path according to a predetermined or specific standard. The first file processing path is a path requested to be processed by file processing request unit 100 and may be, for example, “root>Instagram>data>picture>aaa.jpg” where “pictures>” is inserted to the lower end of the root. The second file processing path is a path changed according to a predetermined standard by file path changing unit 400 and may be, for example, “root>pictures>Instagram>data>picture>aaa.jpg”. File path changing unit 400 may operate in both the framework layer and the kernel layer. File path changing unit 400 may operate in the same layer as the layer where file format discrimination unit 300 is located. File format discrimination unit 300 may not operate in the same layer and may operate in different layers.

File path changing unit 400 may change the file processing path by inserting a predetermined upper directory name into the file processing path. When a file processing request including a file processing path “root>Instagram>data>picture>aaa.jpg” is present in an application, for example, the Instagram application, “pictures>” may be inserted into the upper directory name to make the file path be “root>pictures>Instagram>data>picture>aaa.jpg”. In this case, a folder structure provided by the application is maintained as a lower folder path. So, for example, when backing up pictures, the entire folder “Pictures” including all image files may be backed up at one time while the folder structure used in each application is maintained.

File path changing unit 400 may change the file processing path by setting only a predetermined or specific upper directory of the file processing path. For example, when a file processing request including a file processing path “root>INSTAGRAM>data>picture>aaa.jpg” is used in the INSTAGRAM application, “root>INSTAGRAM>data>picture>” at the lower end of the root can be changed to “root>picture>” so that the file processing path is changed to “root>pictures>aaa.jpg”. When the file processing request is saving a file, a folder structure of the file path used by the application may not be maintained. Rather, all files may be stored in a single folder. In addition, in this case, filenames may be modified to request a file having a path “root>pictures>aaa.jpg” based on the time when files are stored so as to prevent files being saved in duplication.

File path setting unit 410 determines the file processing path to be changed by file path changing unit 400. File path setting unit 410 may operate in the application layer, similar to file format setting unit 310. File path setting unit 410 may basically set the file processing path to be changed by file path changing unit 400 or may set the path according to the selection of a user or according to an arbitrary input.

File processing unit 500 receives a file processing request from file manipulation interface unit 200 for processing (for example, saving or loading) a file in/from the storage unit. File processing unit 500 processes the file referenced by the file processing path included in the file processing request received from file manipulation interface unit 200. For example, file processing unit 500 saves or loads a file by using an API “sys_open (const *filename, int flags, int mode)” where a pathname parameter is delivered from the open API. Here, the filename of the sys_open API is a name of the file, flags are an attribute value, and a mode represents a value which sets the authority of an authorized person. The authorized person may be a file user, a user group or another user, and the authority may be reading, writing and both reading/writing.

File processing unit 500 may store a file in storage unit 600. The first file processing path requested by file processing request unit 100 is changed into a second different file processing path and then the file is stored. Based on the file format discriminated by file format discrimination unit 300 and the file processing path changed by file path changing unit 400 in the framework layer, the file may be stored in storage unit 600. In addition, based on the file format discriminated by file format discrimination unit 300 and the file processing path changed by file path changing unit 400 in the kernel layer, the file may be stored in storage unit 600. File processing unit 500 may also load a file stored in storage unit 600. In the case the file is saved in a state where a first file processing path requested by file processing request unit 100 is changed into a second file processing path, file processing request unit 100 may request loading the corresponding file in the first file processing path as file processing request unit 100 has information about the second file processing path; file processing request unit 100 possesses no information other than the first file processing path. Even though file processing request unit 100 requests loading a file in the first file processing path, the file saved in the second file processing path may be loaded by using the file format discriminated by file format discrimination unit 300 and the file processing path changed by file path changing unit 400. As described above, it is possible to discriminate a file format and change a file processing path in both the framework layer and the kernel layer.

Storage unit 600 stores a file. File processing unit 500 instructs that a file be stored in a designated file processing path. When the file processing path is changed in the framework layer or the kernel layer, the file is stored based on the changed path. In addition, a file stored by storage unit 600 in a file processing path designated by file processing unit 500 may be loaded. Moreover, storage unit 600 may further store a predetermined file format and a second file processing path to be changed from the first file processing path according to the predetermined file format. For example, when a jpg file, “root>Instagram>data>picture>aaa.jpg” is stored as “root>pictures>aaa.jpg”, so that the information “root>pictures>aaa.jpg” is stored to change “root>Instagram>data>picture>” into “root>pictures”. Here, “aaa.jpg” is not an actual filename but an arbitrary form. When a file processing request is received for “root>INSTAGRAM>data>picture>aaa.jpg” by storage unit 600, the file may be processed in the path “root>picture>aaa.jpg”.

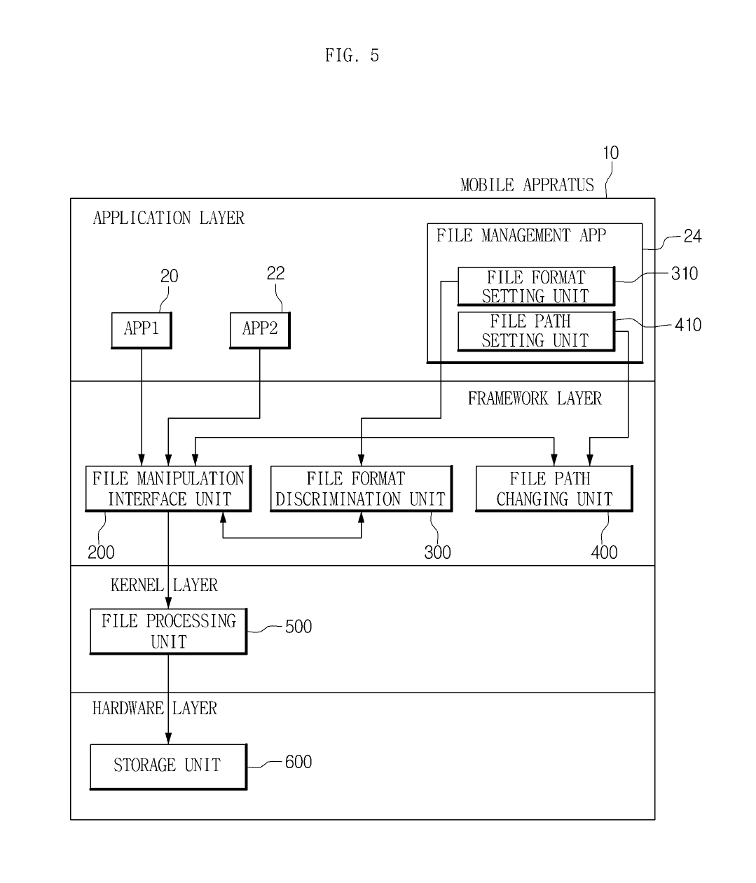

According to the present disclosure, a file desired by a user may be easily backed up by utilizing the common file processing path. In some embodiments, mobile apparatus 10 may also include a back-up unit (SHOWN AS APP2 OF FIG. 5) for automatically backing up all files stored in the file processing path set by file path setting unit 410. The back-up unit can be deployed in the application layer as an application, for example, APP2 of FIG. 5. In some embodiments, back-up unit application can be a privileged or rooted application. Back-up unit may back up files to an internal memory of mobile apparatus 10. Back-up unit may back up files to an internal memory of mobile apparatus 10 an external memory. In some embodiments, files may be backed up, automatically or after a user's request, in a cloud system using the communication unit (not shown) provided in mobile apparatus 10. The cloud system may be accessible via an application in the application layer as an application, for example, APP2 of FIG. 5. In addition, mobile apparatus 10 may include a security setting unit for selectively setting security or access attributes of files stored in the file processing path set by file path setting unit 410. The security setting unit can be deployed in the application layer as an application, for example, APP2 of FIG. 5. Further, mobile apparatus 10 may include a preview unit for providing previews of files stored in the file processing path set by file path setting unit 410. The preview unit can be deployed in the application layer as an application, for example, APP2 of FIG. 5.

FIG. 5 is a diagram illustrating a configuration of a mobile apparatus according to exemplary embodiments of the present disclosure. FIG. 5 illustrates information exchange among components in mobile apparatus 10 when a file format is discriminated and changed in the framework layer. App1 20 and App2 22 represent file processing request unit 100. A file processing request is received through file manipulation interface unit 200. In response, file processing unit 500 processes, namely saves or loads, a file in/from storage unit 600. A file processing path processed by the file manipulation interface may be discriminated by file format discrimination unit 300 and changed by file path changing unit 400. In addition, file format discrimination unit 300 and file path changing unit 400 may change or set other conditions by a file format setting unit 310 and a file path setting unit 410 in a file management application 24 provided in the application layer.

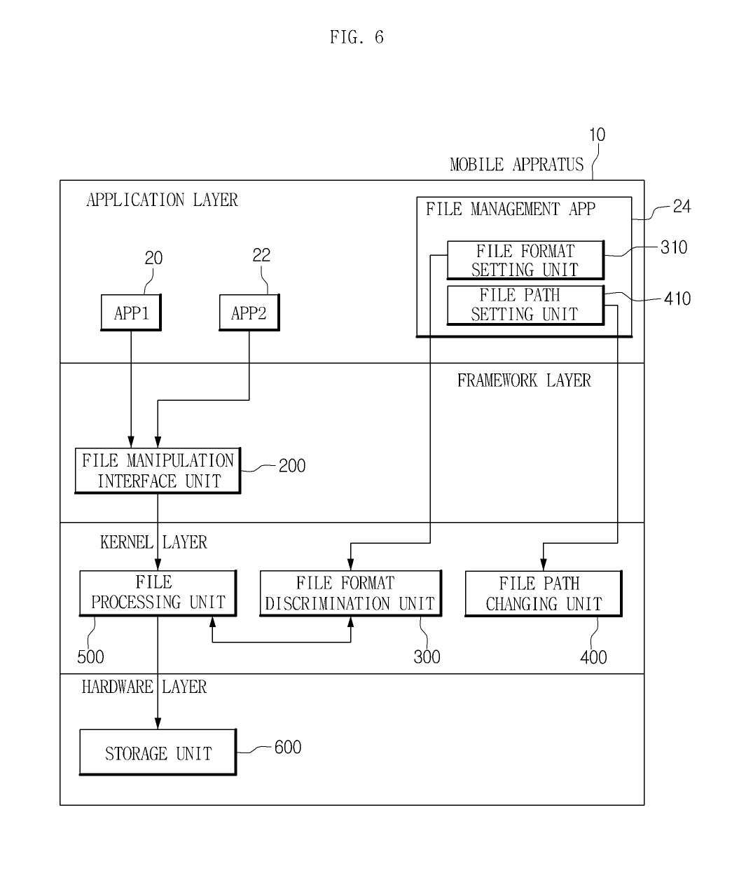

FIG. 6 is a diagram showing a configuration of a mobile apparatus according to exemplary embodiments of the present disclosure. FIG. 6 illustrates information exchanges among components in mobile apparatus 10 when a file format is discriminated and changed in the kernel layer. App1 20 and App2 22 represent a file processing request unit 100, similar to FIG. 5. A file processing request is received through a file manipulation interface unit 200, and this request allows a file processing unit 500 to process, namely to save or load, a file in/from a storage unit 600. A file format discrimination unit 300 may discriminate whether a file has a predetermined format. A file path changing unit 400 may change the file processing path, based on the file processing path passing through file processing unit 500. File format discrimination unit 300 and file path changing unit 400 may read and change file properties (setting conditions) by a file format setting unit 310 and a file path setting unit 410 in a file management application 24 deployed in the application layer.

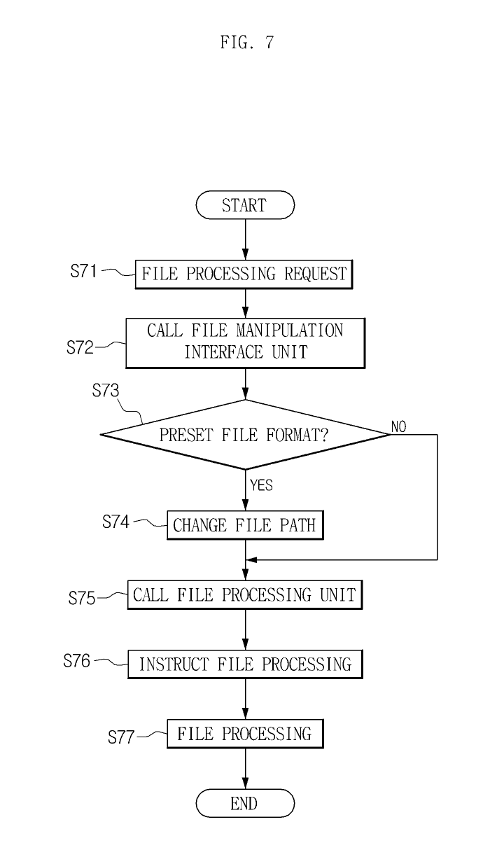

FIG. 7 is a flowchart illustrating a method for processing files according to exemplary embodiments of the present disclosure. FIG. 7 illustrates a file processing procedure of a mobile apparatus 10 when a file format is discriminated and changed in the framework layer. First, a file processing request S71 is received in the application layer. For example, when an application uses a file saving operation or a file loading operation, a file processing request including a file processing path is received. File manipulation interface unit 200 is called S72 to transfer the file processing path. Next it is determined whether or not the file has a preset file format S73 based on the file processing path of the file manipulation interface unit 200. When the file is determined to have a preset file format (S73, YES), the file processing path is changed into a preset path S74. When the file does not have a preset file format (S73, NO), the file processing path is unaltered and maintained as is. Next, file processing unit 500 is called on the changed or unchanged file processing path S75. Accordingly file processing is instructed S76 and the file is processed based on the designated file processing path, for example the file is saved in or loaded from the file processing path S77.

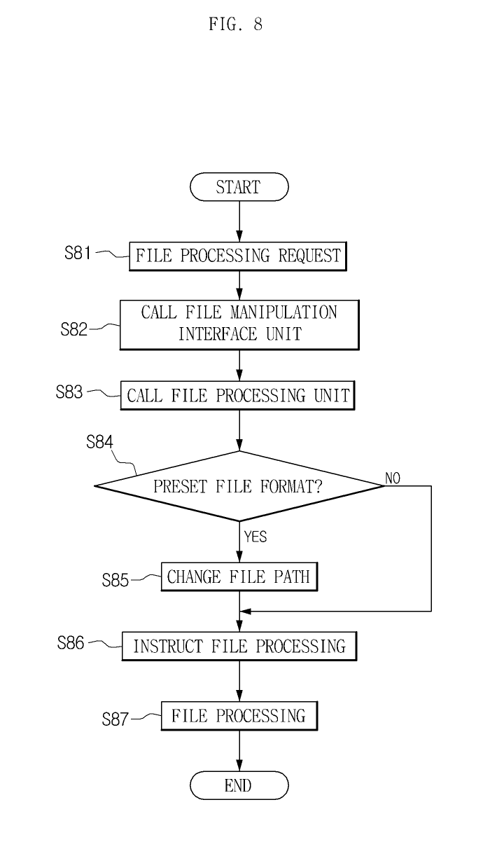

FIG. 8 is a flowchart for illustrating a method for processing files according to exemplary embodiments of the present disclosure. FIG. 8 is illustrates a file processing procedure of the mobile apparatus 10 when a file format is discriminated and changed in the kernel layer. First, a file processing request S81 is received in the application layer. For example, when an application uses a file saving operation or a file loading operation, a file processing request including a file processing path is received. File manipulation interface unit 200 is called S82 to transfer the file processing path, and the file processing path is transferred to file processing unit 500 S83. File processing unit 500 determines whether the file processing path does or does not have a preset file format S84. In case file has a preset file format (S84, YES), the file processing path is changed S85 into the preset path. When the file does not have a preset file format (S84, NO), the file processing path is maintained or remains unaltered. File processing is completed based on the changed or unchanged file processing path S86, and the file is processed in the designated file processing path. For example the file is saved in or loaded from the file processing path S87.

Embodiments of the present disclosure may be implemented as program commands executable by various kinds of computers and processors and recorded on computer-readable media. The computer-readable media may include program commands, data files, data structures or the like, solely or in combination. The program commands recorded on the media may be specially designed for the present disclosure or well known to and available by those skilled in the computer software art. The computer-readable media include, for example, magnetic media such as hard disks, floppy disks and magnetic tapes, optical media such as CD-ROM and DVD, magneto-optical media such as floptical disks, and hardware devices such as ROM, RAM and flash memories, which are specially configured to store and perform program commands. The program commands include machine language codes made by compilers and high-level language codes which may be executed by a computer via an interpreter or the like. The hardware device may be configured to operate as at least one software module for performing the operations of the present disclosure, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile apparatus to process files comprising:
a file manipulation unit configured to receive a file operation request including a file path from an application;
a file format discrimination unit configured to discriminate a file format from the file path;
a file path changing unit configured to set a target file path based on the file format; and
a file processing unit configured to process the operation request on the target file path.

2. The mobile apparatus of claim 1, wherein the target file path groups files by the file format.

3. The mobile apparatus of claim 1, the file format comprises a plurality of file types.

4. The mobile apparatus of claim 1, wherein the file format is selected from a group comprising an audio file, an image file, a static image file, a moving image file, an audio and moving image file, and a document.

5. The mobile apparatus of claim 1, further comprising a file management application configured to set an attribute of the file path.

6. The mobile apparatus of claim 1, further comprising a backup unit configured to back up a plurality of files by file format.

7. The mobile apparatus of claim 1, wherein the file format comprises an image file and the file format comprises at least one of file types selected from ANI, ANIM, APNG, ART, BEF, BMP, BSAVE, CAL, CIN, CPC, CPT, DPX, ECW, EXR, FITS, FLIC, FPX, GIF, HDRi, ICER, IONS, ICO/CUR, ICS, ILBM, JBIG, JBIG2, JNG, JPEG, JPEG 2000, JPEG-LS, JPEG-HDR, JPEG XR, MNG, MIFF, PBM, PCX, PGF, PGM, PICtor, PNG, PPM, PSD/PSB, PSP, QTVR, RAD, RGBE, SGI, TGA, TIFF, WBMP, WebP, XBM, XCF, XPM, Raw-type CIFF, DNG, ORF, Vector-type AI, CDR, CGM, DXF, EVA, EMF, Gerber, HVIF, IGES, PGML, SVG, VML, WMF, XAR, compound-type CDF, DjVu, EPS, PDF, PICT, PS, SWF, XAML, associated Exchangeable image file format (Exif), and Extensible Metadata Platform (XMP).

8. The mobile apparatus of claim 1, wherein the file operation comprises one or more of creating a file, opening a file, saving a file, reading a file, writing a file, setting an attribute of a file, setting a security parameter of a file, or a combination thereof.

9. The mobile apparatus of claim 1, wherein
when the file format comprises a file type, the target file path comprises the file path and a file-type-specific-directory path, and
when the file format does not comprise the file type, the target file path comprises the file path.

10. A method for processing files comprising:
receiving a file operation request including a file path from an application;
discriminating a file format from the file path;
setting a target file path based on the file format; and
processing the operation request on the target file path.

11. The method of claim 10, wherein the target file path groups files by the file format.

12. The method of claim 10, wherein the file format comprises a plurality of file types.

13. The method of claim 10, wherein the file format is selected from a group comprising an audio file, an image file, a static image file, a moving image file, an audio and moving image file, and a document.

14. The method of claim 10, further comprising setting an attribute of the file path.

15. The method of claim 10, further comprising backing up a plurality of files by file format.

16. The method of claim 10, wherein the file operation comprises one or more of creating a file, opening a file, saving a file, reading a file, writing a file, setting an attribute of a file, setting a security parameter of a file, or a combination thereof.

17. The method of claim 10, wherein
when the file format comprises a file type, the target file path comprises the file path and a file-type-specific-directory path, and
when the file format does not comprise the file type, the target file path comprises the file path.

18. A computer to process files including:
a file format discrimination unit configured to discriminate, in case of receiving a file processing request, whether the file has a file format;
a file path changing unit configured to change, in the case the file is discriminated to have the file format by the file format discrimination unit, a first file processing path included in the file processing request into a second file processing path; and
a storage unit configured to store the file in the second file processing path changed from the file path changing unit.

19. The computer of claim 18, wherein the second file processing path groups files by the file format.

20. The computer of claim 18, wherein the file format comprises a plurality of file types.

21. The computer of claim 18, wherein the file format is selected from a group comprising an audio file, an image file, a static image file, a moving image file, an audio and moving image file, and a document.
